(19) United States
(12) Patent Application Publication
(10) Pub. No.: US 2011/0276441 A1
(43) Pub. Date: Nov. 10, 2011

(54) PROCESS FOR ASSIGNING ACCOUNTING CODES

(76) Inventors: Warren Bond, Craighall (ZA); Andrew Teversham, Craighall (ZA)

(21) Appl. No.: 12/674,523

(22) PCT Filed: Aug. 21, 2008
(86) PCT No.: PCT/ZA08/00075

§ 371 Date: May 7, 2010

(51) Int. Cl. G06Q 40/00

(52) U.S. Cl. 705/30

(57) ABSTRACT

A process for assignment of accounting codes and/or sales tax provisions upon recordal of a transaction on the transaction system of a banking institution characterised in that includes the steps of communicating a pre-determined list of accounting code categories to the transactor, selection of one or more appropriate categories by the transactor, assignment of the sales tax applicable to the transaction by the transactor, forwarding a message containing the accounting code selected and the sales tax information, to the banking institution, interpretation of the received message by the transaction system, storing the information contained in the message within the transaction system, and forwarding a confirmation of the receipt to the transactor.

### TECHNICAL FIELD OF THE INVENTION

This invention relates to a process for assigning accounting codes to transactions to facilitate preparation of accounting statements and financial reports directly from the records of a banking institution, minimising bookkeeping functions required to be carried out by the bank customer.

### BACKGROUND ART

In the applicant's patents ZA 2005/10108 and ZA 2006/02615, an accounting process was described in which transactions are categorised at the time of carrying out the transaction, be it in front of a bank teller, ATM, internet banking interface, telephone banking interface or the like, and allocated a transaction code which is captured immediately. This permits an accounting function to be carried out by software designed for this purpose, with the result that management accounts and other financial reports may be prepared, for the customer, in real-time, by either the banking institution or the customer, depending on the service requested by the customer. The accounting codes are assigned from a pre-defined list which is generated by the bank, in consultation with its customer if necessary.

It aims at providing financial accounting and reporting, primarily for bank clients, from a bank based on-line accounting system that is fed automatically with bank transaction information from clients' bank accounts. It is not focussed on the bank's internal accounting requirements. The clients' accounting transactions are generated in the bank based instant accounting system thus facilitating the on-line financial accounting reporting for clients, up to date at any time.

Where the customer is transacting via internet banking, or at an ATM or with a bank teller, the process of assigning the accounting codes is easily and instantly done, as the customer can be prompted with a list of accounting codes. However, where the customer transacts in a different environment and, for example, makes a cheque or cash payment to a supplier, or receives a cheque or cash in settlement of a debt, or even makes a credit or debit card purchase, the assignment of the accounting code cannot be provided to the bank instantaneously. Similarly sales tax or other sales tax information for these transactions is required to be transmitted to the bank in order for it to carry out its accounting service function.

It is therefore an object of this invention to provide a process to permit accurate, swift and timeous recording of the accounting information (G/L Category code and sale tax information) in the banking institution's bank based instant accounting system, either at the instigation of the customer, or prompted by a transaction in the banking institution's systems. A further object of the invention is to provide a process to:
1. Provide easily accessible channels to capture accounting data at any time desired by the user.
2. Provide question and answer (from a limited choice pick-list)
3. Provide reminders triggered by transactions, as close as possible to the transaction time so that the accounting code or category can be easily and correctly assigned
4. Provide a low cost solution, using facilities and communication channels commonly available at any time.
5. Facilitate accounting information collection and storage.
6. Facilitate up to date accounting records at any time, to facilitate complete accounting reports and business management at any time
7. Provide convenient accounting facilities to clients who may only have mobile devices (e.g. phones or PDA's) with internet connectivity at their disposal at any particular time.

In this specification, sales tax may include sales tax, G.S.T or other taxes levied on transactions.

In FIG. 2 the additional (marked with an asterisk) represent, in principle, where the unique invention (the assignment of accounting codes) described below in this specification fits into this bank hosted instant accounting process to provide instant mobile accounting services.

### THE INVENTION

A process for assignment of accounting codes and/or sales tax provisions upon the recordal of a transaction on the transaction system of a banking institution includes the steps of communicating a pre-determined list of accounting code categories to the transactor, selection of one or more appropriate categories by the transactor, assignment of the sales tax applicable to the transaction by the transactor, forwarding a message containing the accounting code selected and the sales tax information, to the banking institution, interpretation of the received message by the transaction system, storing the information contained in the message within the transaction system, and forwarding a confirmation of the receipt to the transactor.

The communication of the pre-determined list of accounting code categories to the transactor may occur by one or more of the following methods:

1) by means of an SMS (Short Message Service/text message) message to the cellular telephone of the transactor

2) by means of a link to an interactive (wireless application protocol) WAP site accessible from the cellular telephone or PDA (personal digital assistant), the WAP site including a category pick-list.

3) by logging into a cellular telephone banking application containing a category pick list.

4) by linking to an interactive website containing a category pick list from a personal computer.

5) by means of an email sent to the transactor by means of an SMTP (simple mail transfer protocol) server.

If methods 1) or 5) are used, the pre-determined list of accounting code categories are downloaded to the cellular telephone or personal computer of the transactor where they are accessible in template form and from which the transactor makes his-her selection.

If methods 2), 3) or 4) are used, the applicable application is provided with category pick-lists which are served to the transactor's cellular telephone or web browser.

In use, there are three possible methods or triggers for the step of communicating the pre-determined list of accounting code categories.

In the first instance, this communication step is initiated by the banking transaction system. In this form, upon registration of the transaction on the system, the system includes a notification engine which, generates a notification message to the transactor via SMS and/or email, that the accounting code and sales tax assignment must be selected. The transactor must then respond by one of the five methods described above. If no response is received from the transactor, the transaction system selects a default accounting category or leaves the category unassigned.

A full description of this form of the process is described below in Scenario 1.

### Scenario 1: System Initiated Assignments

Overview:

A transaction in the Bank/financial institutions systems triggers a notification to the user. The user confirms an accounting category and sales tax information assignments and sends an electronic assignment message back to the bank's systems.

This includes receipts into and payments from a banking account or any financial account at the host bank/financial institution. This also includes credit card transactions.

Process Description:
1. A financial transaction is initiated through the banks transaction systems.
2. A notification is sent to the registered cell phone accounting user, together with the most likely (best-fit) accounting category and assignment for the transaction, based on a category and assignment mapping stored centrally on the host bank's systems.
This is effected through a Notification Engine. The Notification Engine detects any new transaction which has not been assigned an accounting category, and generates a message to be sent to the transactor's registered phone number or e-mail address.
3. The user can receive the notification by SMS text message on his/her registered cell phone, or by e-mail message to his/her registered e-mail address or any other electronic message to his/her registered address. If the client has elected to receive SMS messages, the Notification Engine sends a message via the SMS Message gateway to the client's mobile device. If the client has elected to receive e-mail messages, the Notification Engine sends the message to the client's e-mail address via the SMTP Server.
4. If the user chooses not to respond, the bank based accounting system will retain the default accounting category and assignment it has already calculated as the most likely choice.
5. Alternatively the user can select an alternative category from a list, or key in an alternative valid category and assignment, and send a reply message to change the accounting category and assignments on the bank's systems. The user can choose from various electronic communication channels to make this changed accounting category assignment on the centralised bank based accounting systems at the host bank.
   a. SMS message: The user creates a reply SMS message on his/her cell phone, selects or adds the correct accounting category assignment and information, and sends the SMS reply message which is routed to the bank's systems at the host bank. This uses standard features of SMS text messaging on a mobile communication network.
   b. E-mail message: The user creates a reply e-mail message, selects or adds the correct accounting category assignment and information, and sends the e-mail reply message to the bank's systems at the host bank. This uses standard features of e-mail messaging through the internet.
   c. Cell phone banking: The user follows a link from the SMS message on his/her cell phone to connect to the host bank's cell phone banking application, calling up the latest transaction, and makes the correct category and sales tax information assignments for the transaction. This uses standard cell phone banking communication mechanisms to transmit the selected accounting code. The uniqueness in this invention is that accounting codes and sales tax indicators are assigned to transactions through this channel, thus facilitating the on-line financial accounting reporting for clients. This requires the addition of an accounting code, and sales tax indicator per transaction in the bank's cell phone/mobile banking applications.
   d. WAP site: The user follows a link from the SMS message on his/her cell phone to connect to the host bank's WAP site for bank based instant accounting, automatically calling up the same transaction, and a pick-list of the most relevant accounting categories, and makes the correct category and sales tax information assignments for the transaction. This is effected through the standard internet connection from the mobile device to a dedicated specialized WAP or simplified web page within the bank hosted instant accounting application. In this case an accounting assignment is created directly in the bank based instant accounting database (not requiring a message interpretation (step 6 below), since it uses an interactive WAP or web application page)
   e. WWW site: The user follows a link from the email or SMS message on his/her PC or cell phone to connect to the host bank's Web site for bank based instant accounting, automatically calling up the same transaction, and a pick-list of the most relevant accounting categories, and makes the correct category and sales tax information assignment for the transaction. This is effected through the standard internet connection from the PC or mobile device to a dedicated specialized web page within the bank hosted instant accounting application. In this case an accounting assignment is created directly in the bank based instant accounting database (not requiring a message interpretation (step 6 below), since it uses an interactive web application page)
6. The host bank's systems receive the message, interpret the message, and make the appropriate account assignment entries in the bank's systems. The SMS text message or e-mail message received by the bank's systems is then linked to the original message and transaction, and the accounting records in the bank's instant accounting database are updated with the correct accounting category code and sales tax information.
7. The bank now has up to date accounting information stored together with the transaction data, ready for on-line financial and accounting reports for the client at any time.

### Scenario 2: User/Manually initiated Assignments

In the second instance, the process of communicating and selecting the accounting codes and sales tax allocation is initiated by the transactor. In this form, when the transactor issues or receives a cheque promissory note or Letter of Credit (L.O.C.) he/she then enters the transaction on a cellular telephone or personal computer application which generates the communication to the banking transaction system by one of the five methods described above.

The full description of this form of the process is described below as Scenario 2:

Overview

The user pre-assigns transactions that will later be effected through bank account. The user initiates a transaction that is initially performed outside of the bank's transaction systems. The user creates a message from scratch or from a template or from an accounting category pick-list, assigns an accounting category and sales tax information, and sends an electronic assignment message to the bank. Once the transaction is effected in the bank's systems, it will be automatically matched with this pre-assignment.

This includes receipts and issues of cheques, promissory notes, Letters of Credit (LOC's), and any initial financial actions that can later result in transaction in the bank's transaction systems.

Process Description:
1. A financial transaction is initiated by the user.
2. In this Scenario no notification message is sent to the client as in Scenario 1 above. The user opens an application on his/her cell phone or PC. The user enters the details of the transaction: amount, partner code or name, and optionally: a sales tax indicator, a date (if the transaction date is different to the current date), and a description/reference. The user can also select a category from a list, or key in any valid category, and send a notification message to the bank's systems.
The user can choose from various cell phone or PC based applications and electronic communication channels to make this accounting category assignment on the centralised bank based accounting systems at the host bank:
   a. SMS message: The user creates an SMS message on his/her cell phone or mobile device, adds the transaction details and correct accounting category and sales tax assignments, and sends the SMS message to the bank based accounting systems at the host bank. This can use either a free text format or a pre-formatted SMS text message template. The message transmission uses standard features of SMS text messaging on a mobile communication network.
   b. E-mail message: The user creates an e-mail message, adds the transaction details and correct accounting category and sales tax assignments, and sends the e-mail message to the bank based accounting systems at the host bank. This can use either a free text format or a pre-formatted e-mail message template or form. The message transmission uses standard features of e-mail messaging through the internet.
   c. Cell phone banking: The user connects to the host bank's cell phone banking application, enters the transaction details and, and makes the correct category and sales tax assignments for the transaction This uses standard cell phone banking communication mechanisms to transmit accounting transaction information. The uniqueness in this invention is that accounting transactions are generated through this channel thus facilitating the on-line financial accounting reporting for clients. This requires the addition of an accounting code, and sales tax indicator per transaction in the bank's cell phone/mobile banking applications, and the facility to forward this information to the host bank's instant accounting application.
   d. WAP site: The user, on his/her cell phone, connects to the host bank's WAP site for bank based accounting, enters the transaction details and selects an accounting category from a pick-list of the most relevant accounting categories The user may optionally also makes a sales tax assignment. This is effected through the standard internet connection from the mobile device to a dedicated specialized WAP or simplified web page within the bank hosted instant accounting application. In this case an accounting transaction (e.g. open cheque or invoice) is created directly in the bank based instant accounting database (not requiring a message interpretation (step 3 below), since it uses an interactive WAP or web application page)
   e. WWW site: The user, on his/her PC or cell phone, connects to the host bank's web site for bank based accounting, enters the transaction details and selects an accounting category from a pick-list of the most relevant accounting categories. The user may optionally also make a sales tax assignment. This is effected through the standard internet connection from the PC or mobile device to a dedicated specialized web page within the bank hosted instant accounting application. In this case an accounting transaction (e.g. open cheque or invoice) is created directly in the bank based instant accounting database (not requiring a message interpretation (step 3 below), since it uses an interactive web application page)
3. The SMS text message, or e-mail message received by the bank's systems is then used to create an accounting transaction (e.g. open cheque or invoice), in the bank's instant accounting database with the correct accounting category code and sales tax information.
4. When the banking transaction is later effected through the bank's transaction systems, it will be automatically imported into the bank hosted instant accounting database and matched to this accounting transaction and assigned to the correct accounting category and sales tax information.
5. The bank now has up to date accounting information stored together with the transaction data, ready for on-line financial and accounting reports for the client at any time.

### Scenario 3: External Transactions

In the third form of the process of the invention, the transactor assigns financial transactions that will not be processed through the banking institutions transaction system, but will later be available as accounting information within the banking institutions data stores. These transactions relate to cash payments or receipts, or payments, receipts or transactions effected through an account at another banking institution as well as transactions related to debtors, creditors, invoicing and journal entries. In this case neither the account nor the transactions are linked to the host bank's transaction system.

In this form, the transactor again initiates the process by entering the transaction data on his/her cellular telephone or personal computer application. Thereafter the pre-determined list of accounting codes is communicated by means of one of the five methods described above.

A full description of this external transaction process is described below as Scenario 3.

Overview

The user assigns financial transactions that will not go through the bank's transaction systems, but will later be available as accounting information within the bank hosted instant accounting system.

The user initiates a transaction that is performed outside of the bank's transaction systems. The user creates a message from scratch or from a template or from an accounting category pick-list, assigns an accounting category and sales tax information, and sends an electronic assignment message to the bank. Once the transaction is stored in the bank based instant accounting database, it will be available as accounting information augmenting other bank transaction based accounting information.

This includes cash payment and receipts, and any other transactions through any bank transaction accounts which will not be linked to accounting linked transaction accounts at the host bank. Possible additional transactions include invoices, debtors, creditors and journal entries.

Process Description:
1. A financial transaction (e.g. a cash payment or receipt or invoice) is initiated by the user.
2. In this Scenario no notification message is sent to the client as in Scenario 1 above. The user opens an application on his/her cell phone or PC. The user enters the details of the transaction: amount, partner code or name, and optionally: a sales tax indicator, a date (if the transaction date is different to the current date), and a description/reference. The user can also select a category from a list, or key in any valid category, and send a notification message to the bank's systems.
The user can choose from various cell phone or PC based applications and electronic communication channels to make this accounting category assignment on the centralised bank based accounting systems at the host bank.
   a. SMS message: The user creates an SMS message on his/her cell phone or mobile device, adds the transaction details and correct accounting category and sales tax assignments, and sends the SMS message to the bank's systems at the host bank. This can use either a free text format or a pre-formatted SMS text message template. The message transmission uses standard features of SMS text messaging on a mobile communication network.
   b. E-mail message: The user creates an e-mail message, adds the transaction details and correct accounting category and sales tax assignments, and sends the e-mail message to the bank's systems at the host bank. This can use either a free text format or a pre-formatted e-mail message template or form. The message transmission uses standard features of e-mail messaging through the internet.
   c. Cell phone banking: The user connects to the host bank's cell phone banking application, enters the transaction details and, and makes the correct category and sales tax assignments for the transaction. This uses standard cell phone banking communication mechanisms to transmit accounting transaction information. The uniqueness in this invention is that accounting transactions are generated through this channel thus facilitating the on-line financial accounting reporting for clients. This requires the addition of an accounting code, and sales tax indicator per transaction in the bank's cell phone/mobile banking applications, and the facility to forward this information to the host bank's instant accounting application.
   d. WAP site: The user, on his/her cell phone, connects to the host bank's WAP site for bank based accounting, enters the transaction details and selects an accounting category from a pick-list of the most relevant accounting categories. The user may optionally also make a sales tax assignment. This is effected through the standard internet connection from the mobile device to a dedicated specialized WAP or simplified web page within the bank hosted instant accounting application. In this case an accounting transaction (e.g. a cash payment or receipt or invoice) is created directly in the bank based instant accounting database (not requiring a message interpretation (step 3 below), since it uses an interactive WAP or web application page)
   e. WWW site: The user, on his/her PC or cell phone, connects to the host bank's web site for bank based accounting, enters the transaction details and selects an accounting category from a pick-list of the most relevant accounting categories. The user may optionally also make a sales tax assignment. This is effected through the standard internet connection from the PC or mobile device to a dedicated specialized web page within the bank hosted instant accounting application. In this case an accounting transaction (e.g. a cash payment or receipt or invoice) is created directly in the bank based instant accounting database (not requiring a message interpretation (step 3 below), since it uses an interactive web application page)
3. The SMS text message, or e-mail message received by the bank's systems is then used to create an accounting transaction (e.g. a cash payment or receipt or invoice), in the bank's instant accounting database with the correct accounting category code and sales tax information.
4. The bank now has up to date accounting information from external non-bank transactions, which together with other bank transaction related accounting category and sales tax information, facilitates the bank based on-line instant accounting financial reports for clients at any time.

In this specification, a banking transaction system is understood to means a banking transaction system which includes an accounting process/system as described in the Applicant's patents ZA2005/10108 and ZA2006/02615.

1. A process for assignment of accounting codes and/or sales tax provisions upon recordal of a transaction on the transaction system of a banking institution characterised in that includes the steps of communicating a pre-determined list of accounting code categories to the transactor, selection of one or more appropriate categories by the transactor, assignment of the sales tax applicable to the transaction by the transactor, forwarding a message containing the accounting code selected and the sales tax information, to the banking institution, interpretation of the received message by the transaction system, storing the information contained in the message within the transaction system, and forwarding a confirmation of the receipt to the transactor.

2. A process according to claim 1 characterised in that the communication of the pre-determined list of accounting code categories to the transactor occurs by means of short message service (sms/text message) to the cellular telephone of the transactor.

3. A process according to claim 1 characterised in that the communication of the pre-determined list of accounting code categories to the transactor occurs by means of a link to an interactive WAP site accessible from the cellular telephone or PDA of the transactor.

4. A process according to claim 1 characterised in that the communication of the pre-determined list of accounting code categories to the transactor occurs by means of logging on to a cellular telephone banking application.

5. A process according to claim 1 characterised in that the communication of the pre-determined list of accounting code categories to the transactor occurs by means of linking to an interactive website from a personal computer.

6. A process according to claim 1 characterised in that the communication of the pre-determined list of accounting code categories to the transactor occurs by means of an email sent to the transactor by an SMTP server.

7. A process according to claim 2 characterised in that the pre-determined list of accounting code categories downloaded to the cellular telephone or personal computer of the transactor is accessible in template form, the transactor making a selection from the template.

8. A process according to claim 3 characterised in that the transactor makes an accounting code category selection from the pick-list.

9. A process according to claim 1 characterised in that the step of communicating the pre-determined list of accounting codes categories is initiated by the baking transaction system.

10. A process according to claim 9 characterised in that the banking transaction system includes a notification engine which detects any new transaction to which an accounting category code has not been assigned and generates a notification message to be sent to the cellular telephone or PDA or email address of the transactor.

11. A process according to claim 10 characterised in that the notification message contains a best-fit accounting category code and sales tax assignment for the transaction, the best-fit being selected by the banking transaction system from an accounting code category and sales tax mapping stored therein.

12. A process according to claim 10 characterised in that the message is an SMS and is sent by means of an SMS message gateway.

13. A process according to claim 10 characterised in that the message is an email and is sent by means of an SMTP server.

14. A process to claim 1 characterised in that in the event that the transactor does not respond to the message sent, the banking transaction system selects a default accounting code category.

15. A process according to claim 14 characterised in that the default accounting code category and sales tax assignment is the best-fit assignment.

16. A process according to claim 1 characterised in that in the event that the transactor does not respond to the message sent, the banking transaction system leaves the category unassigned.

17. A process according to claim 1 characterised in that the transactor sends a reply message in response to the notification message by means of an sms or email.

18. A process according to claim 17 characterised in that the reply message confirm the best-fit assignment.

19. A process according to claim 17 characterised in that the reply message contains an alternative valid accounting code category and sales tax assignment and initiates the banking transaction system to change the best-fit assignment.

20. A process according to claim 17 characterised in that the banking transaction system receives the reply message, interprets the reply message and effects the appropriate accounting code and sales tax assignment entries in the banking transaction system.

21. A process according to claim 3 characterised in that the banking transaction system includes a dedicated WAP site, the transactor following a link from the notification SMS message on his/her cellular telephone to connect to the bank's WAP site, the establishment of the connection causing the site to call up the same transaction together with a pick-list of accounting categories and sales tax assignment, selection thereof effecting automatic assignment in the banking transaction system.

22. A process according to claim 4 characterised in that the banking transaction system includes a cellular telephone banking application, the transactor following a link from the notification sms message to the cellular telephone banking application, the establishment of the connection thereto causing the application to call up the latest transaction together with a pick-list of accounting code categories and sales tax assignments, selection thereof effecting automatic assignment in the banking transaction system.

23. A process to claim 5 characterised in that the banking transaction system includes an internet website, the transactor following a link from the notification email or sms message from a person computer or cellular telephone or PDA, the establishment of the connection thereto causing the application to call up the latest transaction together with a pick-list of accounting code categories and sales tax assignments, selection thereof effecting automatic assignment in the banking transaction system.

24. A process according to claim 1 characterised in that the transactor initiates the assignment of the accounting code category and sales tax assignment from a cellular telephone/PDA or personal computer.

25. A process according to claim 24 characterised in that the transactor creates an SMS message on his/her cellphone or PDA, adds the transaction details and correct accounting category and sales tax assignments, and sends the SMS message to the bank.

26. A process according to claim 25 characterised in that the sms comprises a free text format.

27. A process according to claim 25 characterised in that the sms comprises a pre-formatted sms text message template.

28. A process according to claim 25 characterised in that the sms message received by the bank's system is then used to create an accounting transaction (e.g. open cheque or invoice) in the bank's instant accounting database with the correct accounting category code and sales tax information.

29. A process according to claim 24 characterised in that the transactor creates an email message, adds the transaction details and correct accounting category and sales tax assignments, and send the email message to the banking transaction system.

30. A process according to claim 29 characterised in that the email message comprises a free text format.

31. A process according to claim 29 characterised in that the email message comprises a pre-formatted email message template,

32. A process according to claim 29 characterised in that the email message received by the bank's systems is then used to create an accounting transaction (e.g. open cheque or invoice), in the bank's instant accounting database with the correct accounting category code and sales tax information.

33. A process according to claim 24 characterised in that the transactor connects to the cellular telephone banking application of the banking transaction system by means of a cellular telephone or PDA, enters the transaction details and makes the correct category and sales tax assignments for the transaction.

34. A process according to claim 24 characterised in that the transactor connects to the WAP site of the banking transaction system by means of a cellular telephone or PDA enters the transaction details and selects an accounting category from a pick list of the most relevant accounting categories.

35. A process according to claim 34 characterised in the transactor optimally selects a sales tax assignment.

36. A process according to claim 24 characterised in that the transactor connects to the web site of the banking transaction system enters the transaction details and selects an accounting category from a pick-list of the most relevant accounting categories.

37. A process according to claim 36 characterised in that the transactor optionally selects a sales tax assignment.

38. A process according to claim 34 characterised in that an accounting transaction (for example open cheque or invoice) is created directly in the banking transaction system database.

39. A process according to claim 28 characterised in that this accounting transaction is later matched to the corresponding baking transaction and the correct accounting code category and sales tax information assignment thereto.

40. A process according to claim 39 characterised in that the transactor assigns financial transactions that will not be processed through the banking institutions transaction system, but will late be available as accounting information within the banking institutions data stores, these transactions including cash payments or receipts, or payments, receipts or transactions effected through an account at another banking institution as well as transactions related to debtors, creditors, invoicing and journal entries, neither these transactions nor the transactors' account being linked to the banking transaction system.

41. A process according to claim 40 characterised in that these transactions are initiated by the transactor by entering the transaction data on a cellular telephone or personal computer application.

42. A process according to claim 41 characterised in that the transactor creates an SMS message on his/her cell phone or mobile device, adds the transaction details and correct accounting category and sales tax assignments, and sends the SMS message to the bank's systems at the host bank.

43. A process according to claim 42 characterised in that the sms message comprises a free text format.

44. A process according to claim 42 characterised in that the sms message comprises a pre-formatted sms text message template.

45. A process according to claim 41 characterised in that the transactor creates an email message, adds the transaction details and correct accounting category and sales tax assignments, and sends the email message to the bank's systems at the host bank.

46. A process according to claim 45 characterised in that the email message comprise a free text format.

47. A process according to claim 45 characterised in that the email message comprises a pre-formatted email message template.

48. A process according to claim 41 characterised in that the transactor connects to the cellphone banking application of the banking transaction system enters the transaction details and makes the correct category and sales tax assignments for the transaction.

49. A process according to claim 41 characterised in that the transactor connects to the WAP site of the banking transaction system enters the transaction details and selects an accounting category from a pick-list of the most relevant accounting categories.

50. A process according to claim 49 characterised in that the transactor optionally selects a sales tax assignment.

51. A process according to claim 41 the transactor connects to the web site of the banking transaction system, enters the transaction details and selects an accounting category from a pick-list of the most relevant accounting categories.

52. A process according to claim 51 characterised in that the transactor optionally selects a sales tax assignment.

53. A process according to claim 41 characterised in that the sms text message, or email message received by the bank's systems is then used to create an accounting transaction (e.g. a cash payment or receipt or invoice) in the bank's instant accounting database with the correct accounting category code and sales tax information.

54. (canceled)
